(19) United States
(12) Patent Application Publication
(10) Pub. No.: US 2006/0038671 A1
(43) Pub. Date: Feb. 23, 2006

(54) Automobile and motorcycle automatic direction indicating device

(76) Inventor: Shiang-Sheng Cheng, Yung-Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/920,334

(22) Filed: Aug. 18, 2004

(51) Int. Cl. B60Q 1/34

(52) U.S. Cl. 340/465

(57) ABSTRACT

An automobile and motorcycle automatic direction indicating device includes a voltage stabilizer 2, a left switch 3, a right switch 4, a left and a right direction indicating light 5 and 6. The left and the right switch both connected to the voltage stabilizer, and then the left switch is connected to the left direction indicating light, and the right switch is connected to the right direction indicating light. Turning on and off of both the left and the right switch is controlled by a steering wheel shaft 7. The left switch or the right switch is turned on by the steering wheel shaft in case of the steering wheel rotated to the left side or the right side. The left and the right indicating light both are turned off by the steering wheel shaft in case of the steering wheel rotated to the neutral center position.

### BACKGROUND OF THE INVENTION

1. Field of the Invention

This invention relates to an automobile and motorcycle automatic direction indicating device, particularly to one automatically lighting up a left or a right indicating light when a driver begins to rotate the steering wheel to the left side or the right side for changing the running direction of an automobile or a motorcycle, by the shaft of the steering wheel rotated by the steering wheel turns on the left or the right switch respectively for the left indicating light or the right indicating light.

2. Description of the Prior Art

Conventional automobiles and motorcycles are not provided with an automatic device for turning on the left or right indicating light, so drivers have to manually handle the switch for the left or the right indicating light to give a warning to those running behind that one. But the chances are that the driver may mishandle or forget to cause troubles.

### SUMMARY OF THE INVENTION

This invention offers an automobile and motorcycle automatic direction indicating device to automatically give out a warning to automobiles and motorcycles running behind the one indicating the direction light so as to keep safety in traffic.

The feature of the invention is a voltage stabilizer connected respectively to a left switch and a right switch, and a left indicating light and a right indicating light respectively connected to the left or the right switch that are controlled by a steering wheel shaft of an automobile or the shaft of a handle of a motorcycle.

### BRIEF DESCRIPTION OF DRAWINGS

This invention will be better understood by referring to the accompanying drawings, wherein:

FIG. 1 is a block diagram of the automobile and motorcycle automatic direction indicating device in the present invention;

FIG. 2 is an electric circuit of the automobile and motorcycle automatic direction indicating device in the present invention;

FIG. 3 is a flow chart of the function of the automobile and motorcycle automatic direction indicating device in the present invention; and,

FIG. 4 is a perspective view of the direction lights in the present invention.

### DETAILED DESCRIPTION OF THE PREFERRED EMBODIMENT

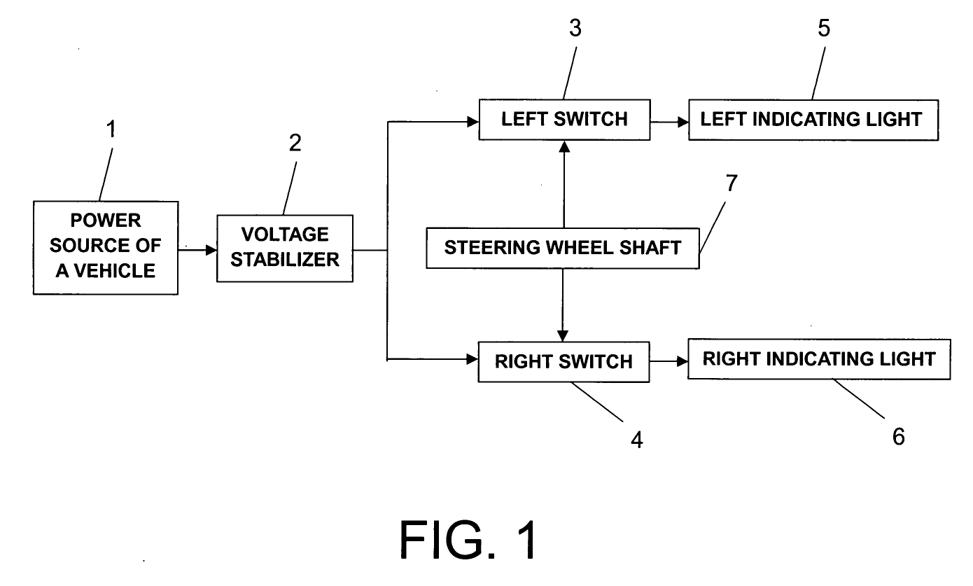

A preferred embodiment of an automobile and motorcycle automatic direction indicating device in the present invention, as shown in FIG. 1, includes a power source 1, a voltage stabilizer 2, a left switch 3, a right switch 4, a left indicating light 5, and a right indicating light 6 as main components.

The voltage stabilizer 2 is electrically connected with the power source 1 and the left switch 3 and the right switch 4. The left switch 3 is then connected electrically to the left indicating light 5, and the right switch 4 is electrically connected to the right indicating light 6. Further, the left and the right switch is turned on and off by a steering wheel shaft 7 of an automobile or the shaft of a handle of a motorcycle.

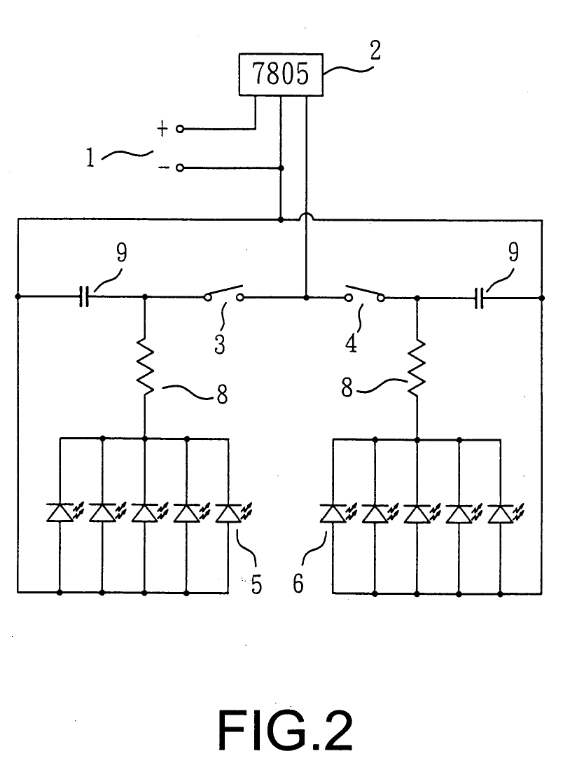

Next, FIG. 2 shows the electric circuit of the automobile and motorcycle automatic direction indicating device, wherein the power source 1 of an automobile or a motorcycle is connected with the voltage stabilizer 2, with the left switch 3 and the right switch 4 both connected to the voltage stabilizer 2, and with a resistor 8 and a capacitor 9 connected between the left light indicating light 5 and the left switch 3 and another resistor 8 and another capacitor 9 connected between the right indicating light 6 and the right switch 4.

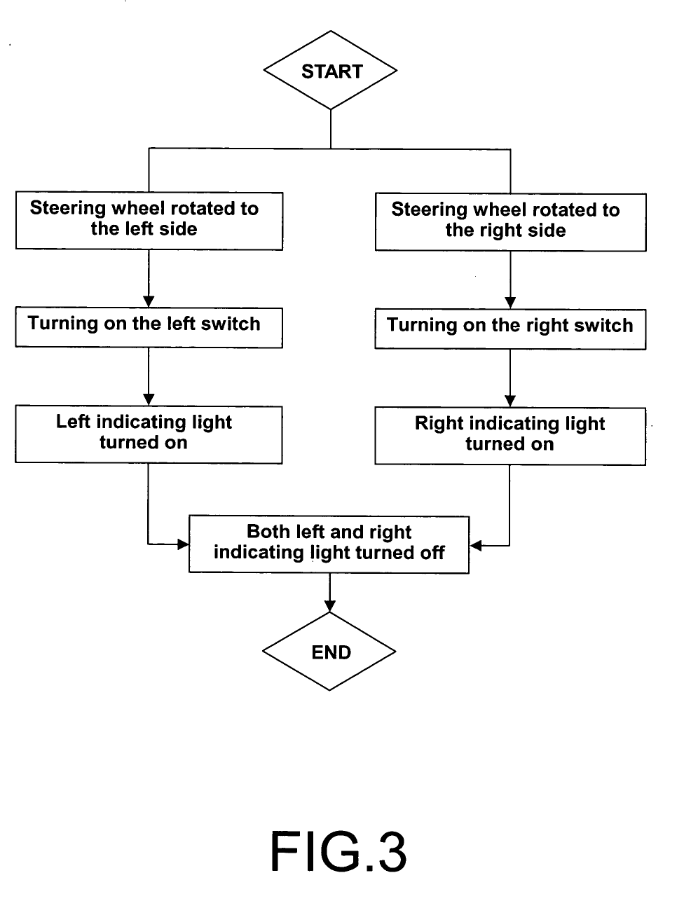

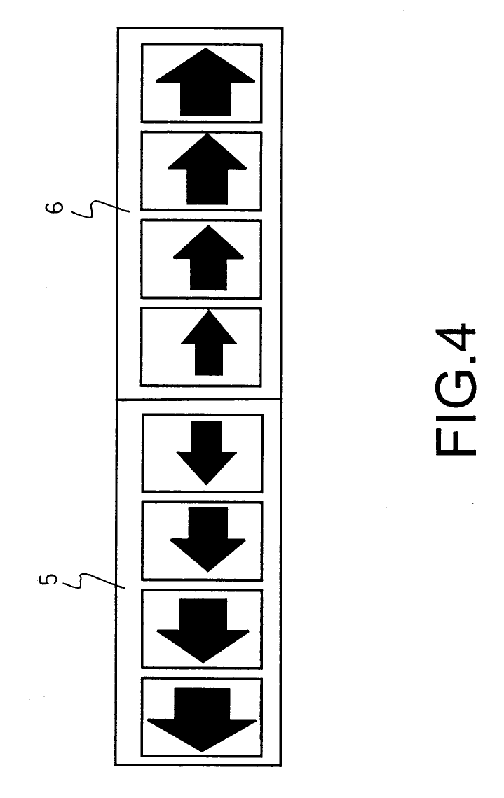

In using, referring to FIGS. 1 to 4, FIG. 3 shows a flow chart of the automatic direction indicating device, showing that the power source 1 supply electricity, which is stabilized and then filtered by the combination of the resistor 8 and the capacitor 9 and then lights up the left or the right direction indicating light 5 or 6 by the function of the steering wheel shaft 7 to turn to the left or the right caused by the steering wheel of an automobile or a handle shaft of a motorcycle. If a driver rotates the steering wheel to the left or to the right for turning the vehicle into the left or the right side, the steering wheel shaft 7 may turn on the left switch or the right switch so that the left or the right indicating light 5 or 6 may be lit up. But if the steering wheel shaft 7 is moved to the neutral center position, the left and the right direction light 5 and 6 both turned off. Thus, vehicles running behind the one can learn the front vehicle is going to change its direction to the left or the right or run straightforward. Therefore, running safety of a vehicle can be obtained, without possibility of forgetting to indicate the changing direction manually as is often the case of a conventional automobile or a motorcycle.

While the preferred embodiment of the invention has been described above, it will be recognized and understood that various modifications may be made therein and the appended claims are intended to cover all such modifications that may fall within the spirit and scope of the invention.

What is claimed is:

1. An automobile and motorcycle automatic direction indicating device comprising a voltage stabilizer connected to a power source of the vehicle, a left switch and a right switch both connected with said voltage stabilizer, said left switch connected to and turned on and off a left direction indicating light, said right switch connected to and turned on and off a right direction indicating light, said left switch and said right switch controlled by a steering wheel shaft of an automobile or a handle shaft of a motorcycle; and,
said steering wheel shaft turning on said left switch to light up said left direction indicating light when said steering wheel is rotated to the left side, said steering wheel shaft turning on said right switch to light up said right direction indicating light when said steering wheel is rotated to the right side, said left and said right direction indicating light both turned off when said steering wheel is turned to the neutral center position, the function of said direction indication device giving an warning to drivers of vehicles running behind the automobile or the motorcycle provided with said direction indicating device so that traffic accidents possible to happen from forgetting to manually handle the direction indicating light of the convention vehicles may be avoided.

2. The automobile and motorcycle automatic direction indicating device as claimed in claim 1, wherein a resistor and a capacitor are connected between said left switch and said left direction indicating light, and a resistor and a capacitor are also connected between said right switch and said right direction indicating light, for limiting current by said resistor each and filtering by said capacitor each.
